(19) United States
(12) Patent Application Publication
(10) Pub. No.: US 2007/0136212 A1
(43) Pub. Date: Jun. 14, 2007

(54) SYSTEMS AND METHODS FOR PROTECTING CONFIDENTIAL INFORMATION THROUGH GEODEMOGRAPHIC INFORMATION AGGREGATION

(75) Inventors: John E. Carpenter, Lakeville, MN (US); Jeffrey A. Johnson, Minneapolis, MN (US)

Correspondence Address: CROMPTON, SEAGER & TUFTE, LLC, 1221 NICOLLET AVENUE, SUITE 800, MINNEAPOLIS, MN, 55403-2420, US

(73) Assignee: EXCENSUS LLC, Lakeville, MN (US)

(21) Appl. No.: 11/672,887

(22) Filed: Feb. 8, 2007

Related U.S. Application Data
(63) Continuation of application No. 11/421,966, filed on Jun. 2, 2006, now abandoned.
Application No. 11/421,966 is a continuation of application No. 09/874,909, filed on Jun. 5, 2001, now abandoned.

(51) Int. Cl. G06F 17/00; G06G 7/00

(52) U.S. Cl. 705/400

(57) ABSTRACT

Systems and methods for providing demographic information for a geo-demographic cluster area within a predefined geographic region are disclosed. An illustrative method may include the steps of associating selected data entries from multiple databases with parcels of land in a predefined geographic region, generating household-specific demographic profiles for each parcel of land using data records from the databases, generating an aggregate dataset for at least two parcels of land by combining the household-specific demographic profiles for each parcel of land, and outputting selective data from the aggregate dataset to a user such as an individual or organization. The step of generating an aggregate dataset for at least two parcels of land can be used to protect the identity of individual residents or organizations located within the predefined geographic region.

This application is a continuation application of U.S. application Ser. No. 11/421,966 filed Jun. 2, 2006, which is a continuation of U.S. application Ser. No. 09/874,909 filed Jun. 5, 2001.

### FIELD OF THE INVENTION

The present invention generally relates to demographic data development and analysis systems, and more particularly, to methods and apparatus for collecting, assembling, analyzing and/or displaying demographic or other data.

### BACKGROUND OF THE INVENTION

Demographic data is used extensively by both industry and government for a wide variety of applications, including decision support and planning. The primary source of residential demographic data is the U.S. Census Bureau, which publishes a comprehensive survey of resident characteristics every ten years. One limitation of the U.S. Census is that demographic changes that occur between census reporting years are not represented. As a result, much of the demographic data that is available between census takings is based on projections or extrapolations from the previous U.S. Census. This can result in significant errors in the data, especially in the later years between census reports.

The U.S. Census has other limitations as well. For many organizations, faced with local or project related decisions, the level of detail needed to support many decisions is simply not available from the U.S. Census. For example, the U.S. Census may not track housing conditions, neighborhood turnover, access to transportation, work force needs, or other demographics that are deemed important to a particular decision or plan. Even if a particular demographic variable is available, the data may not correspond to the desired geographic region. The U.S. Census provides summary data based on relatively large fixed geographic regions, which may not correspond to a desired project or program region, such as a corridor along a major highway, a school district, or a neighborhood. Accordingly, U.S. census data is often not used, or not used effectively, in making local, neighborhood, program, or project level decisions.

As an alternative to the U.S. Census, some communities and organizations have undertaken local surveys to gather additional or more current data for their decision-making needs. Many of these organizations have found local surveys to be cost prohibitive where decision-making needs are at a neighborhood or site planning area. Questions also arise regarding the accuracy or truthfulness of the survey results and the degree to which the survey respondents are representative of the population at large.

### SUMMARY OF THE INVENTION

The present invention relates to systems and methods for producing timely and accurate demographic data that can be particularly helpful for local, neighborhood, program or project level decisions. In a preferred embodiment, this result is accomplished by means of a process that merges and distills demographic characteristics from multiple state, local or other administrative databases and then cross-checks the fundamental household counts by matching addresses to detailed digital property and land use maps, or associated ownership data.

Each of the source databases are selected to provide at least some resident attribute data that is different from the data provided by other source databases. Matching data is also sought as a means to cross-validate the information received. The source database pool may include, for example, a postal service database that identifies street addresses for residential properties in the predefined geographic region. Drivers license data might be added to identify resident names, ages, gender and help determine occupancy dates. Property tax data might be used to identify street addresses, owner names, type of dwelling, property values, and owner/renter status. Motor vehicle registration data would be used as another crosscheck of resident names and occupancy dates while also providing new information on vehicle ownership. Utility billing data generally provides a reliable set of addresses and identifies move-in or move-out dates. School census data helps fill in information regarding children, ethnicity, language spoken and length of time at current address.

Many of these illustrative source databases are regularly updated by an agency or organization responsible for maintaining the database, and may provide relatively up-to-date information. No single agency database is sufficiently accurate or complete for demographic profiling purposes. In combination, using the methods and processes associated with this invention, these databases become a significant resource for producing current and accurate demographic profiles.

The resident attribute data from each of the source databases is linked together by a corresponding street address and/or property identifier within a predefined geographic region. Once associated, records from of the source databases are combined into a new resident-specific dataset grouped by common address. Each address and each current and former resident of an address may be represented by records from many source databases. A processing routine selects and tags pertinent records for each address from the combined dataset and produces a tentative demographic profile for each street address, household, parcel of land or other identifier. For example, the number of people, including children, living at a particular street address, household, or parcel of land may be derived from the union set of demographic information.

If the information in the union set of demographic information is incomplete for some reason, the summary demographic parameters can be modeled or estimated based upon predefined rules using the union set of data. Alternatively, or in addition, the summary demographic parameters can be estimated based upon extrapolations or interpolations from demographic data associated with neighboring street addresses, households in similar housing or living on comparable parcels of land.

To protect the identity of the individual residents within the predefined geographic region, the demographic data for each street address, household, parcel of land or other identifier is rolled together with at least one, but preferably at least two other street addresses, household, parcel of land or identifier. This creates a number of aggregated, summary data records, one for each group or set of adjacent street addresses, households, parcels of land or other identifiers. A number of summary demographic variables are produced for each aggregated grouping. Again, if the information in the aggregated grouping is incomplete, the summary demographic variables can be modeled or estimated, similar to that described above.

An end user of the demographic data is preferably only given access to or able to generate queries from the aggregated summary data records and/or the corresponding summaries, but not the demographic data for each street address, household, parcel of land or other identifier.

For each aggregated grouping, profile variables are produced for mapping or analysis using standard Geographic Information System (GIS) software or custom software applications. Similar to the format of a U.S. Census data file, aggregated information is provided as summary counts that can be used in tables, maps or charts or combined with other aggregated groupings to form larger, user-defined study areas. Data variables may include, but are not limited to, household and population counts, resident and householder ages, size and composition of households, length of time at current address, vehicle ownership, type of dwelling, and value of dwelling. Because of the small geographic clusters, unique types of maps and forecast models can be produced to showing demographic patterns, concentrations and trends.

### BRIEF DESCRIPTION OF THE DRAWINGS

FIG. 1a—a high level schematic diagram of an illustrative embodiment of the present invention;

FIG. 1b—sample layout for school census input data file including student and preschool records with associated child and parent/guardian descriptors;

FIG. 1c—sample layout for property tax data file including ownership, sales and dwelling data by parcel;

FIG. 1d—sample layout for a drivers license database containing driver attributes, home address and issuing dates;

FIG. 1e—sample layout for a vehicle registration data file including vehicle and owner attribute data along with resident address;

FIG. 1f—sample layout for water utility billing database identifying current and previous occupants, as well as service connect/disconnect dates;

FIG. 2—flowchart showing an illustrative method for assembling the geo-demographic cluster area datasets (See #30 of FIG. 1a);

FIGS. 3a-3j—sample layout of a household-level demographic data file produced for each household;

FIG. 4—GIS map of a predefined geographic region having selected demographic data overlaid thereon.

### DETAILED DESCRIPTION OF THE INVENTION

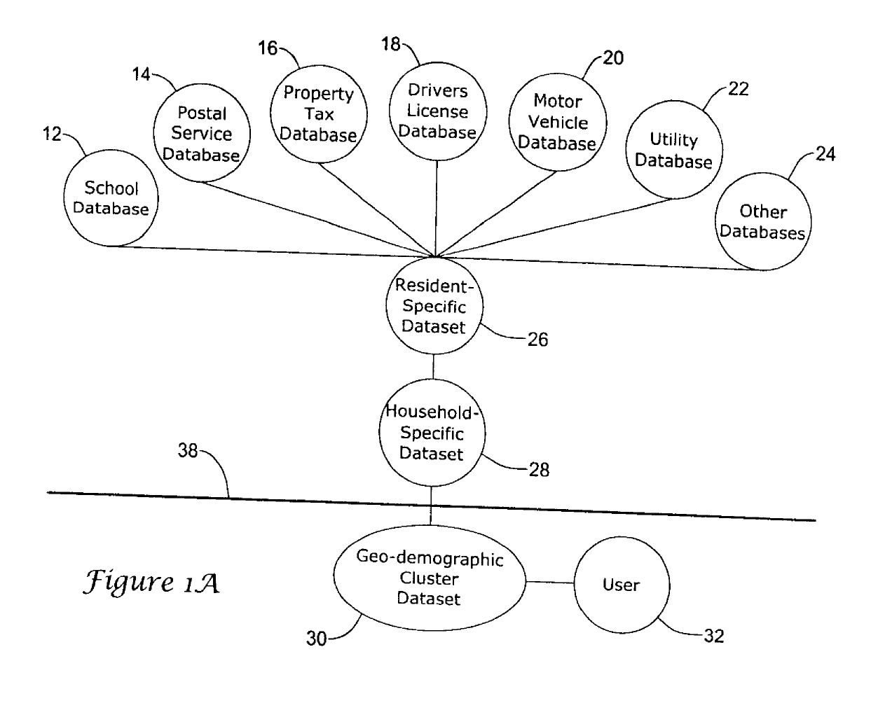

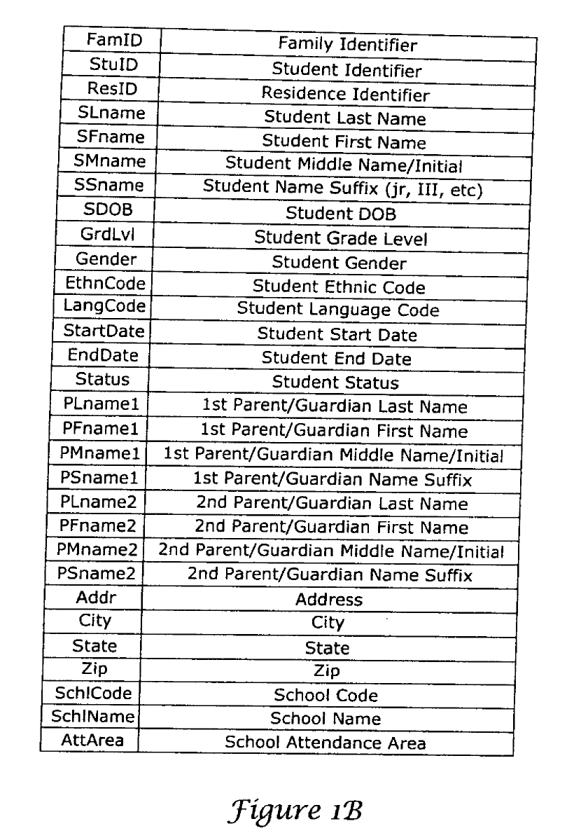

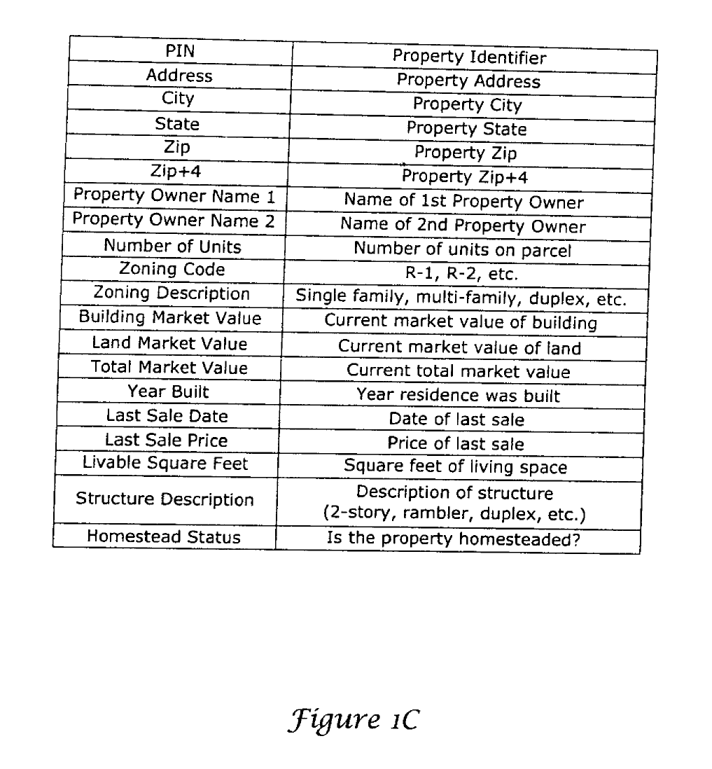

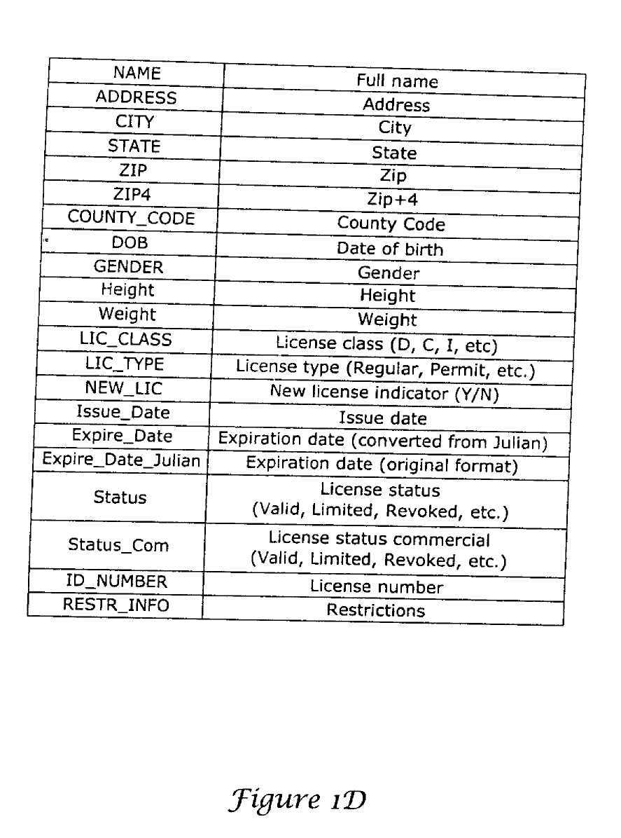

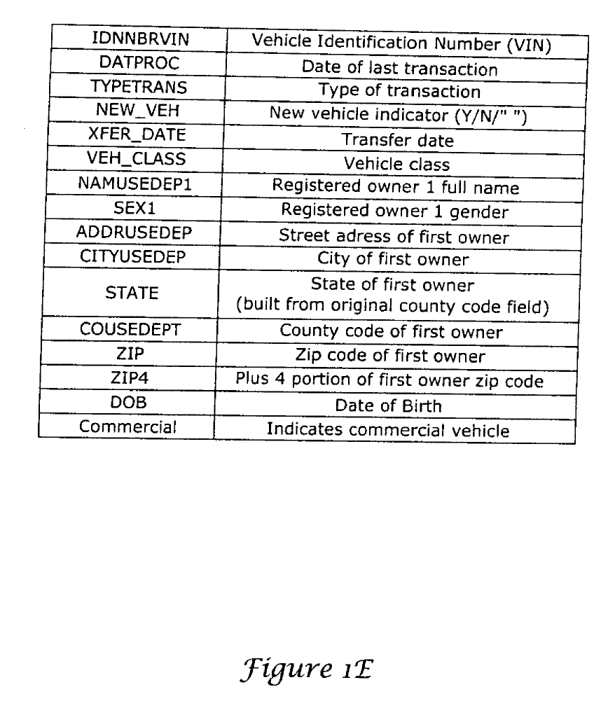

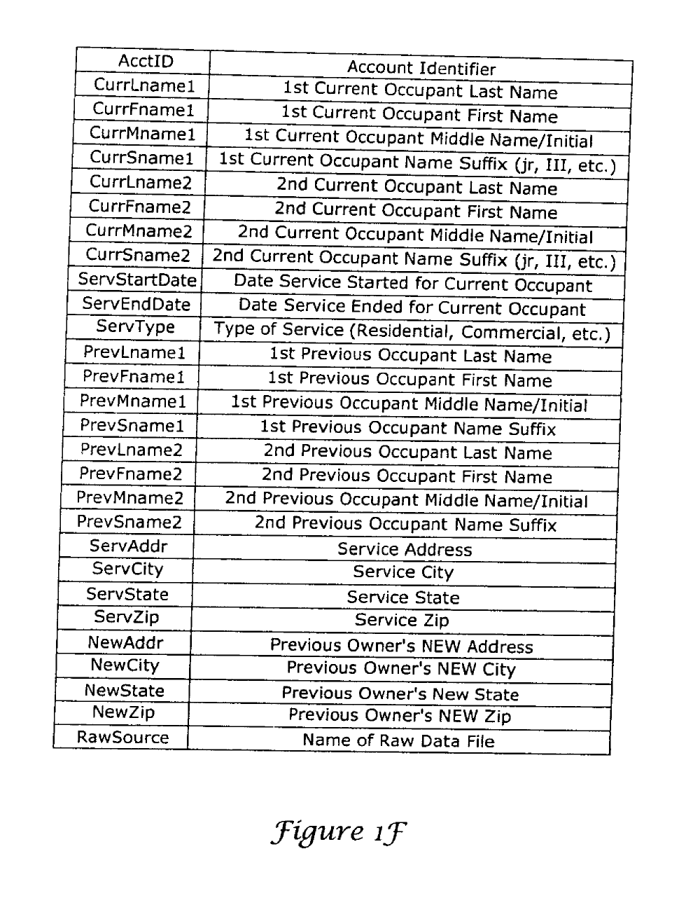

FIG. 1a is a high level schematic diagram of an illustrative embodiment of the present invention. A number of source databases are shown at 12, 14, 16, 18, 20, 22 and 24, each selected to provide at least some resident attribute data that is different from the data provided by the other source databases. Also, the source databases 12, 14, 16, 18, 20, 22 and 24 preferably relate to a predefined geographic region, such as a school enrollment area, a housing renewal area, a transit corridor, a neighborhood, a city, a town, a county, a planning district, a service area of an organization or business, or any other predefined geographic region.

In the illustrative embodiment, source database 12 is a school database that identifies children's names, ages, street addresses, etc. Source database 12 may help identify the children living at each of the street addresses, households, parcels of land, etc. within the predefined geographic region. FIG. 1b is a sample layout for school census database 12 consisting of student and preschool records with associated child and parent/guardian descriptors.

Source database 14 is a postal service database that identifies street addresses in the predefined geographic region. The postal service database may help provide a baseline for a master address file, as further described below.

Source database 16 is a property tax database that identifies the owner's name, the type of dwelling, the value of the property, etc., for each residential parcel of land in the predefined geographic region. FIG. 1c is a sample layout for a property tax database 16 having a number of input fields for parcel of land.

Source database 18 is a drivers license database that may identify the street address, age, gender, etc., for each driver in the predefined geographic region. FIG. 1d is a chart showing illustrative input fields for a drivers license database 18 having a number of input fields for each driver.

Source database 20 is a motor vehicle registration database that identifies the owner's name, street address, registration or renewal date, type of vehicle, etc., for each registered vehicle in the predefined geographic region. FIG. 1e is a chart showing illustrative input fields for a motor vehicle registration database 20 having a number of input fields for each motor vehicle.

Source database 22 is a water utility billing database that identifies street addresses, current and former occupant names, service connect and disconnect dates, etc., within the predefined geographic region. FIG. 1f is a chart showing illustrative input fields for a utility database 22 having a number of input fields for each street address or parcel of land.

Many of the illustrative source databases 12, 14, 16, 18, 20, 22 and 24 are regularly updated by the agency or organization responsible for maintaining the database. Therefore, each of the source databases shown may provide relatively up-to-date information for use by the present invention. No single agency database is sufficiently accurate or complete for demographic profiling purposes in and of itself. In combination, using the methods and processes associated with this invention, these databases become a significant resource for producing current and accurate demographic profiles.

It is contemplated that the resident attribute data contained in the above source databases, and others, may be linked, combined, and synthesized to create demographic profiles of households in the predefined geographic region. These profiles may include many demographic variables including, for example, total population, age distribution, race/ethnicity distribution, age of head of households, household size and composition (adults, children, seniors), attributes of children in school (school, grade, limited English proficiency status, standardized test scores, free and reduced-price lunch participation, etc.), types of dwellings, property values, owner or renters, affordability of owner-occupied homes, home sale date and price, turnover rate for both owner-occupied and rental property, length of time at current address, age of housing, and vehicle ownership.

Some examples of other databases 24 include, for example, Dun and Bradstreet employer data, employee and employer data available from some states' Departments of Economic Security, library cardholder data, voter registration data, crime statistics data, etc. Using such databases, a number of additional demographic variables can be generated including, for example, employment status, household wage income, place of employment (which may be useful in identifying commuting patterns among other things), births, deaths, public assistance usage and crime descriptors (location, type of offense, etc.).

The demographic or other data from each of the source databases, such as source databases 12, 14, 16, 18, 20, 22 and 24, is linked together by a corresponding street address and/or property identifier within the predefined geographic region. In FIG. 1a, the data from each source database 12, 14, 16, 18, 20, 22 and 24 is associated with a corresponding household within the predefined geographic region. This is preferably accomplished by relating the address information in each of the source databases 12, 14, 16, 18, 20, and 22 to a particular household within the predefined geographic region.

Once the data in the various source databases 12, 14, 16, 18, 20, 22, and 24 is associated with a particular household, all records from all of the source databases are combined into a new resident-specific dataset grouped by common address, shown at 26. Each address and each current and former resident of an address may be represented by records from many source databases. A processing routine selects and tags pertinent records for each address in the combined resident-specific dataset and produces a tentative demographic profile for each street address, household, parcel of land, or other identifier. This tentative demographic profile separates current from former residents, and determines the head of household.

Once the pertinent demographic attributes for each resident have been identified and tagged in the resident-specific dataset, the records are collapsed and the demographic variables are summarized at the household level. The result is a new dataset, the household-specific dataset, shown at 28.

To protect the identity of the individual residents or households within a predefined geographic region, the demographic data for each household is preferably rolled together with at least one, but preferably two other households, and more preferably three to four neighboring households. This creates a number of geo-demographic cluster data sets, shown generally at 30. In a preferred embodiment, a number of summary demographic variables are created for each geo-demographic cluster data set.

Each demographic cluster data set is preferably, though not necessarily, created from demographic data from households on contiguous parcels. A contiguous parcel includes a common border with another parcel. The demographic data for households of non-contiguous parcels may also be used to form a demographic cluster data set. A demographic cluster data set may be created by associating demographic data from households on adjacent or proximate parcels or households having common attributes such as having a house of a certain age, being on a lakeshore, near a busy intersection or other physical, geographic or common feature or characteristic. One such characteristic may be that the households are proximate the edge or boundary of the predefined geographic region.

A user 32 of the demographic data is preferably only given access or able to generate queries from the geo-demographic cluster data sets 30 and/or the corresponding summaries, but not the demographic data at the individual household dataset 28 level. This is illustrated by wall 38 disposed between user 32 and household dataset 28 in FIG. 1a. User 32 may include, for example, civic organizations, faith communities, community partnerships, city or country agencies, school districts, nonprofit service providers, advocacy groups, community development groups, foundations, charities, businesses, or any other individual or organization, as desired.

In a preferred embodiment, the user 32 may use the geo-demographic cluster data sets 30 for various past or forward thinking purposes. Examples of uses for the geo-demographic cluster data sets 30 include neighborhood improvement and lobbying efforts, grassroots community organizing, geographic targeting of services or funds, allocating grants and program funding, needs assessment, preparing grant proposals, promoting public awareness, media relations, organizational budget planning, calling together a collaborative effort, site selection for programs, services or businesses, scanning for early signs of neighborhood decline or improvement, locating specific opportunities to add affordable housing, etc.

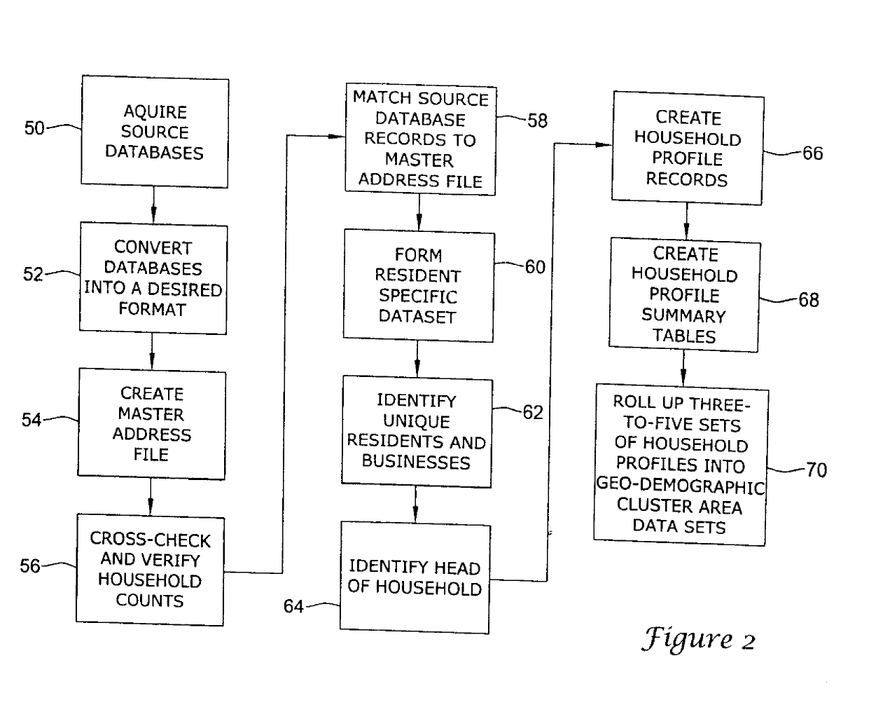

FIG. 2 is a flow chart showing an illustrative method for assembling the geo-demographic cluster dataset 30 of FIG. 1a. The method begins at step 50, wherein a number of source databases are acquired, such as source databases 12, 14, 16, 18, 20, and 22. The source databases may be acquired from various organizations including, for example, local, state, and federal government agencies, utility companies, schools and school districts, commercial organizations or entities such as Dun & Bradstreet, LEXIS-NEXUS, Dialog, etc. Examples of government agencies that may provide source databases include the United States Postal Service, the department of motor vehicles, the property tax assessors office, the department of health, the city water works, the police department, the FBI, the department of transportation, the department of economic security, and others.

Since the source databases may be received from multiple sources, each source database may have to be cleaned, standardized, and/or formatted before use. This is shown at step 52. This is preferably accomplished using one or more data-cleaning programs that identify the relevant data within each raw source database, and output a number of records that are in a desired format. The data-cleaning programs may also initially access the quality and compatibility of the data and identify potential data-scrubbing tasks. For example, the data-cleaning programs may identify and parse multiple names for a particular record (e.g., John and Jane Doe). The data-cleaning programs may also do a rough cleaning of the raw source databases, such as name formatting, address parsing, date formatting, etc., as well as putting this data into a predefined database format, and adding a unique database key that identifies the source database and record. Preferably the addresses are placed into a standardized format using Centrus Desktop Software, commercially available from Sagent Technologies, Inc., Clearwater, Fla. Preferably, the source database records are placed in a file that is compatible with a database program, such as Microsoft Access, Microsoft SQL server, Oracle8i, etc.

Next, and as shown at 54, a master street address file is created. To accomplish this, an initial address file is preferably extracted from residential addresses in the property tax database 16. Then, any new (unmatched) addresses from the postal service database 14 are added. Then, any new (unmatched) addresses from the utility database 22 are added. Once this is completed, a first round of quality checks is performed. For example, the address counts for multifamily properties are preferably compared to known unit counts. Duplex and triplex properties are preferably checked to ensure that each unit has an individual address, and duplicate addresses are eliminated.

Another round of quality checks may also be performed, as shown at 56. During this round of quality checks, address information that is discrepant among the different source databases is reconciled. The basic household counts represented by the master street address file are cross-checked against digital property and land use maps, ownership data files, and/or other local sources of household counts (e.g., local planning agencies). This check ensures an accurate base from which to build household demographic profiles. Some hand checking may also be performed, resulting in a cleaned and corrected master street address file.

Once the master street address file is created, a unique address key may be assigned to each address in the predefined geographic region. Then, the data for each source database 12, 14, 16, 18, 20, 22 and 24 is associated with a corresponding street address or address key, as shown at 58. This is preferably accomplished by relating the address field in each of the source databases 12, 14, 16, 18, 20, 22 and 24 to a particular street address in the master address file.

Once this is complete, any source data that is not associated with an address is reviewed and assigned to an appropriate address, if possible. The number of matches between the addresses in each source database 12, 14, 16, 18, 20, 22 and 24 and the master address file may be maintained, and subsequently compared against the total number of data entries or listings in the corresponding source database. This can be used to determine the extent of non-matches in each source database. Also, the number of matches for each address in the master address file may be maintained to identify those addresses that have a low match rate. Any variations can be investigated and corrected, if desired.

Once the data in the various source databases 12, 14, 16, 18, 20, 22 and 24 is associated with a particular street address, and the above quality checks are complete, all records from all of the source databases are combined into a new resident-specific dataset grouped by common address, as shown at 60. Each address and each current and former resident of an address may be represented by records from many source databases.

A processing routine then traverses the resident-specific dataset and identifies unique persons, evaluates name forms to determine family groupings, and evaluates transaction dates (e.g., license renewal date, etc.) to separate current from former residents. The routine selects and tags pertinent records for each address in the combined resident-specific dataset and produces a tentative demographic profile for each street address, household, parcel of land, or other identifier. This process is shown at 62.—

Next, a head of household may be determined for each address, as shown at 64. This is preferably accomplished by examining the data entries and/or transaction dates associated with each address. If there is a property ownership record, the first person listed in this record may be considered the head of household. Alternatively, or in addition to, if there is no property ownership record, the oldest current resident may be considered the head of household. Where enough data exists to do so, one head of household is tagged for each household grouping of records in the resident-specific dataset. If the information in the resident-specific dataset is deemed incomplete for some reason, the demographic variables can be modeled or estimated based upon-predefined rules. For example, if the age of a parent is unknown but the age of the children are known, one rule may be “add 25 years to the oldest child's age to yield the age of the parent”.

In a more detailed example, the age of a head of household is modeled. A check is first made to determine if the household has a spouse and if the age of the spouse is known. If so, then the age of the spouse is used as a proxy for the age of the head of household. If not, a check is made to determine if the household includes one or more children. If the household does include one or more children, and the age of the children are known, then the age of the head of household is computed as 25 years plus the age of the eldest child. If the household does not include children, then the age of the head of household is extrapolated or interpolated from the ages of the heads of households of nearby or neighboring households.

Alternatively, or in addition, the missing demographic parameters can be estimated based upon extrapolations or interpolations from demographic data associated with neighboring households.

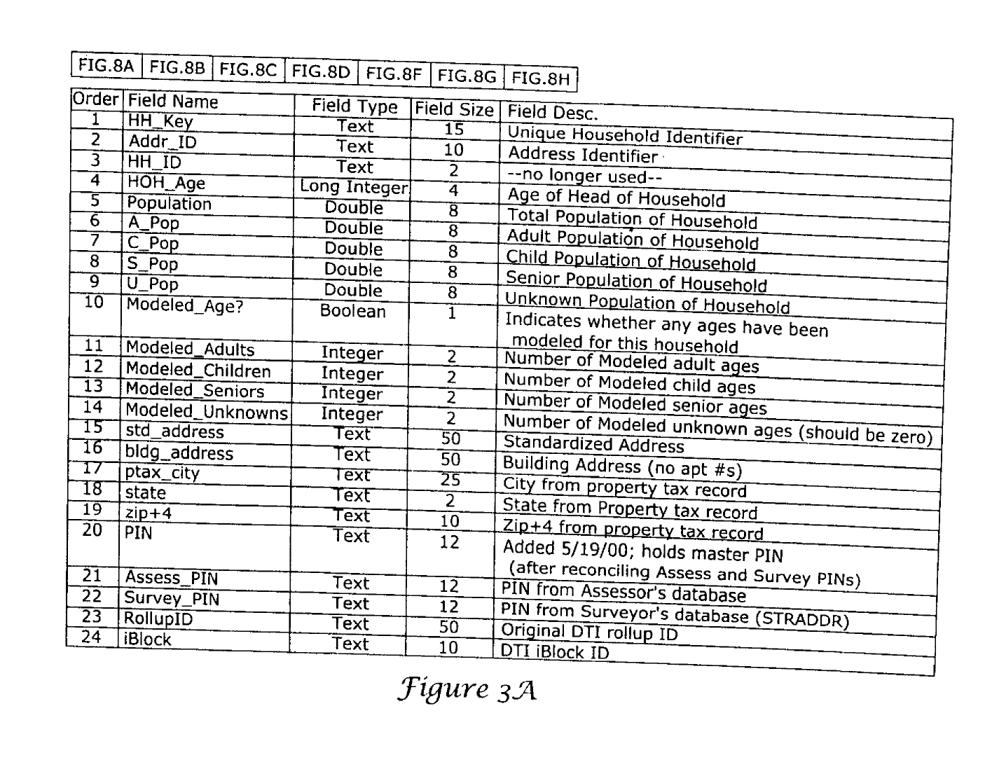

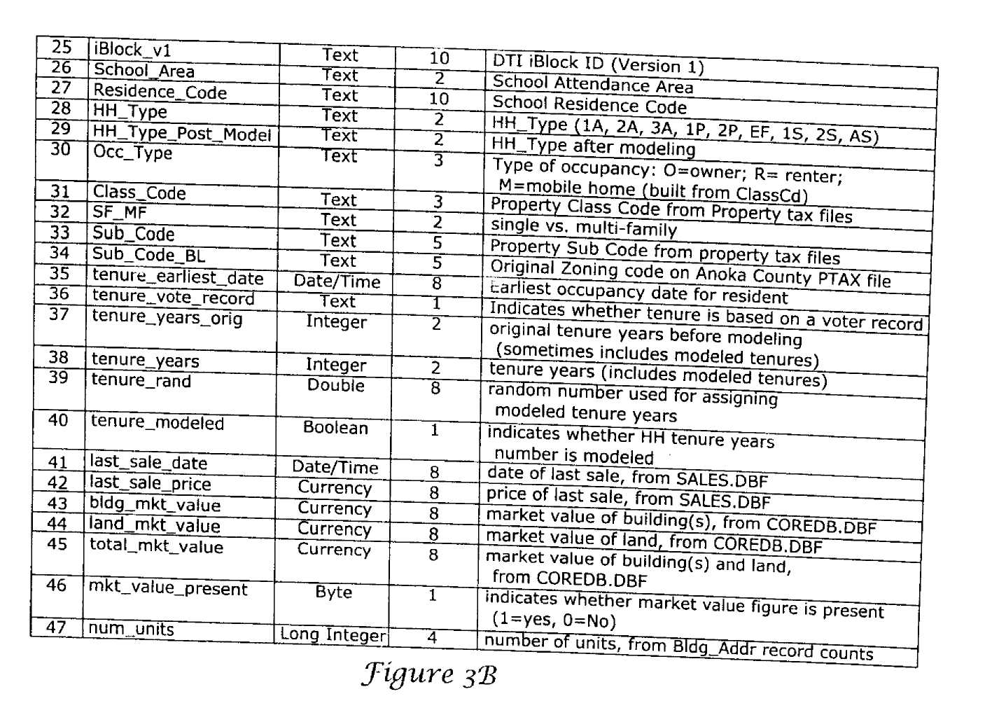

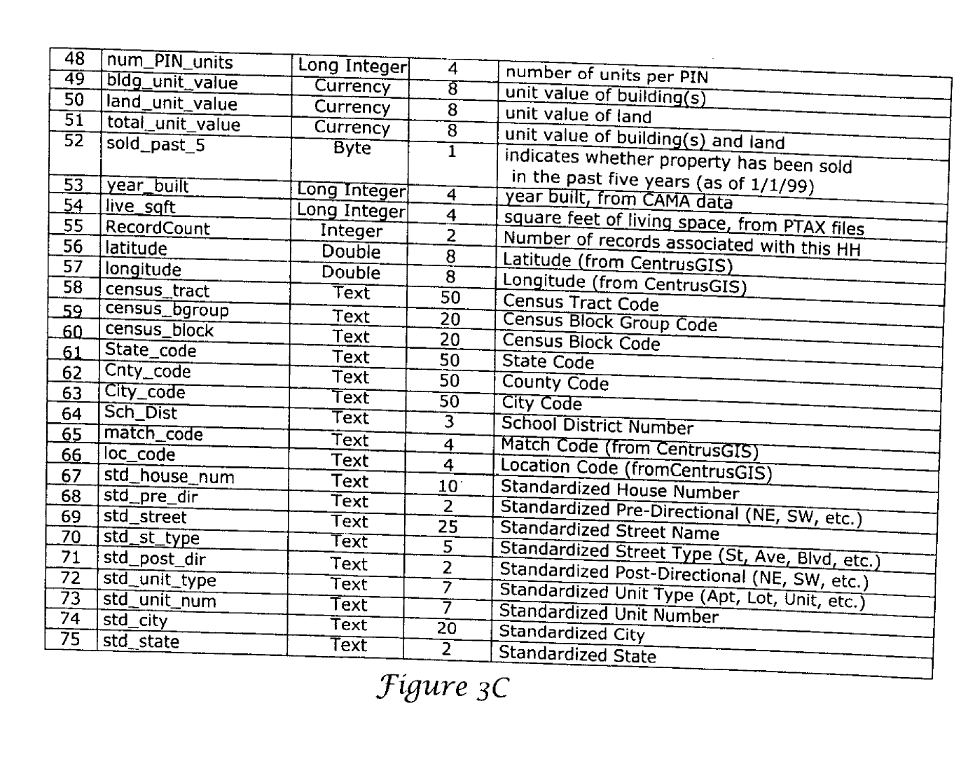

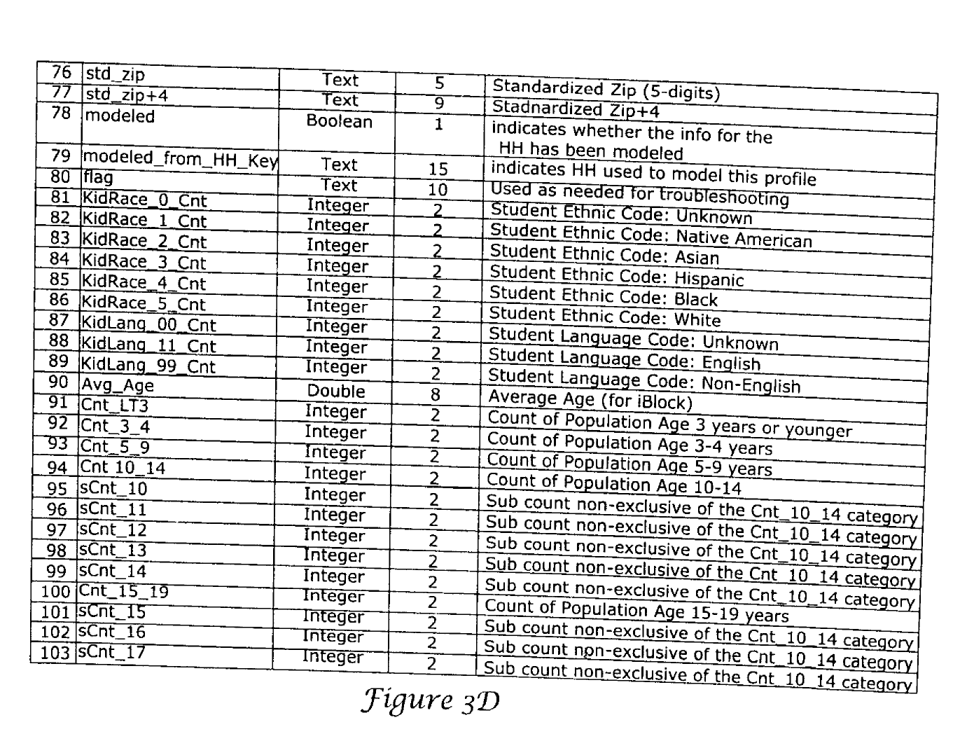

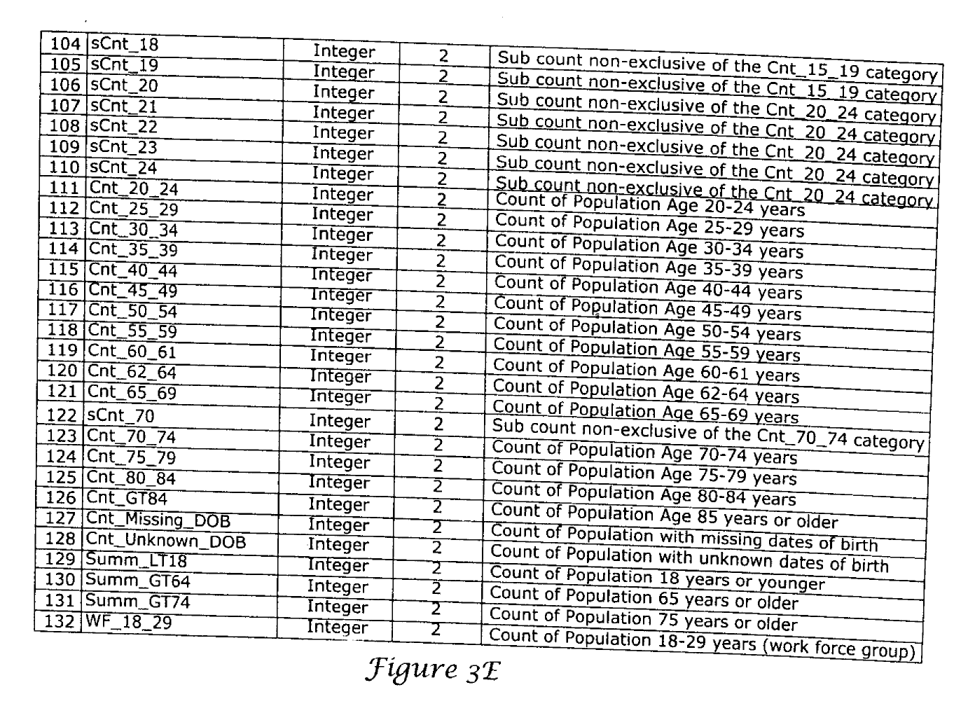

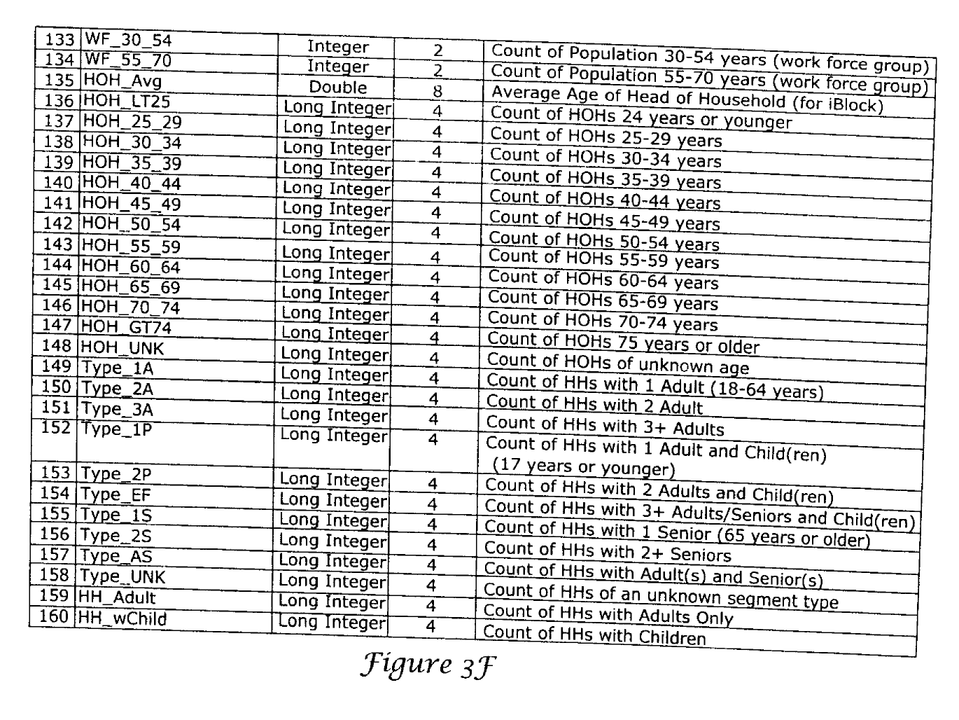

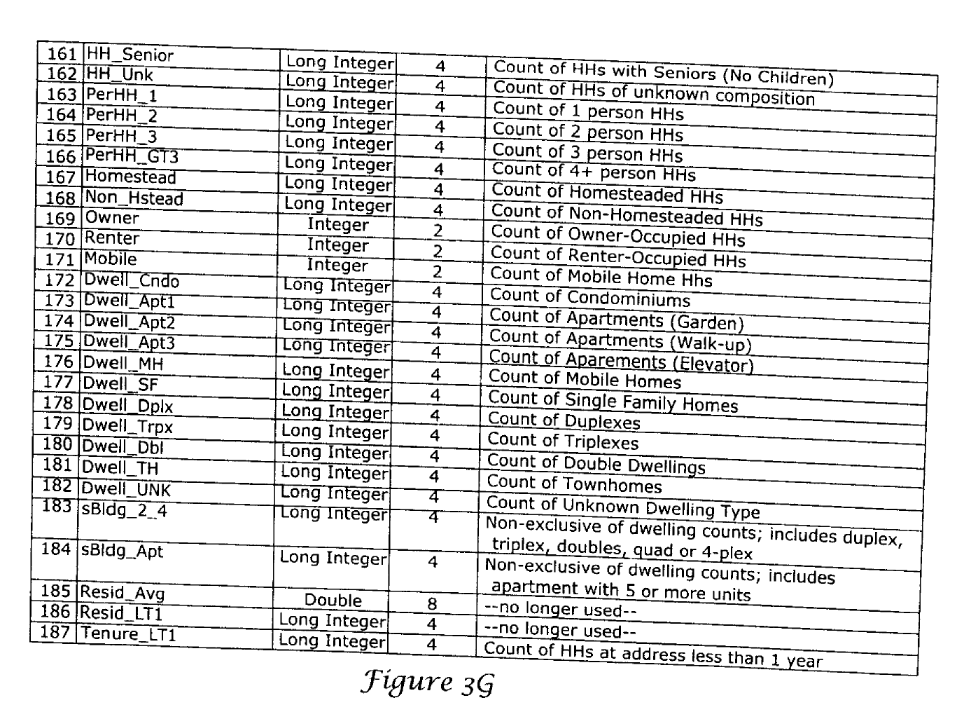

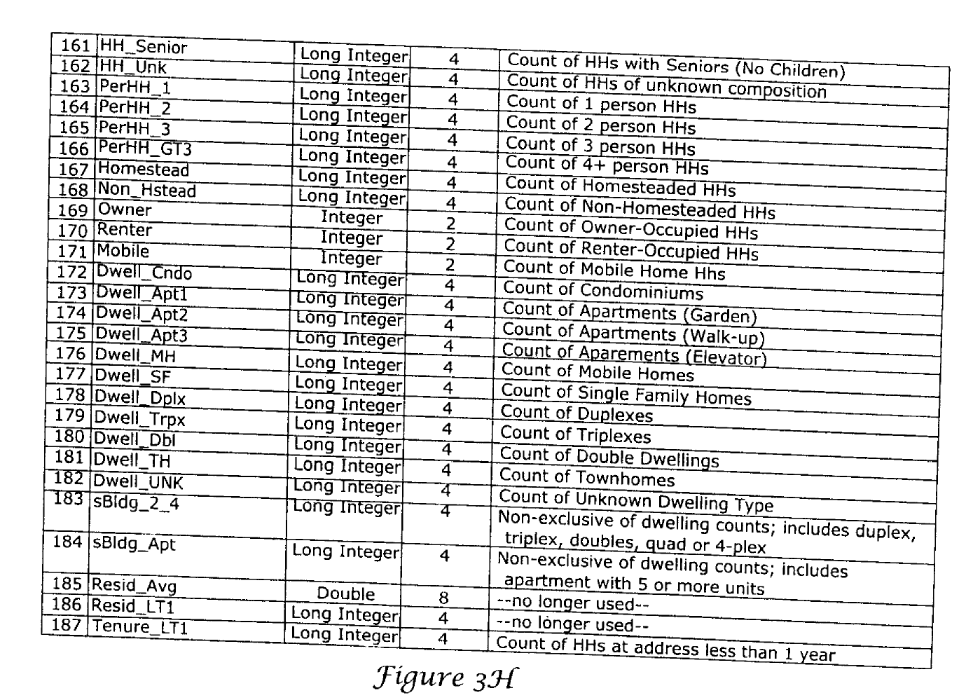

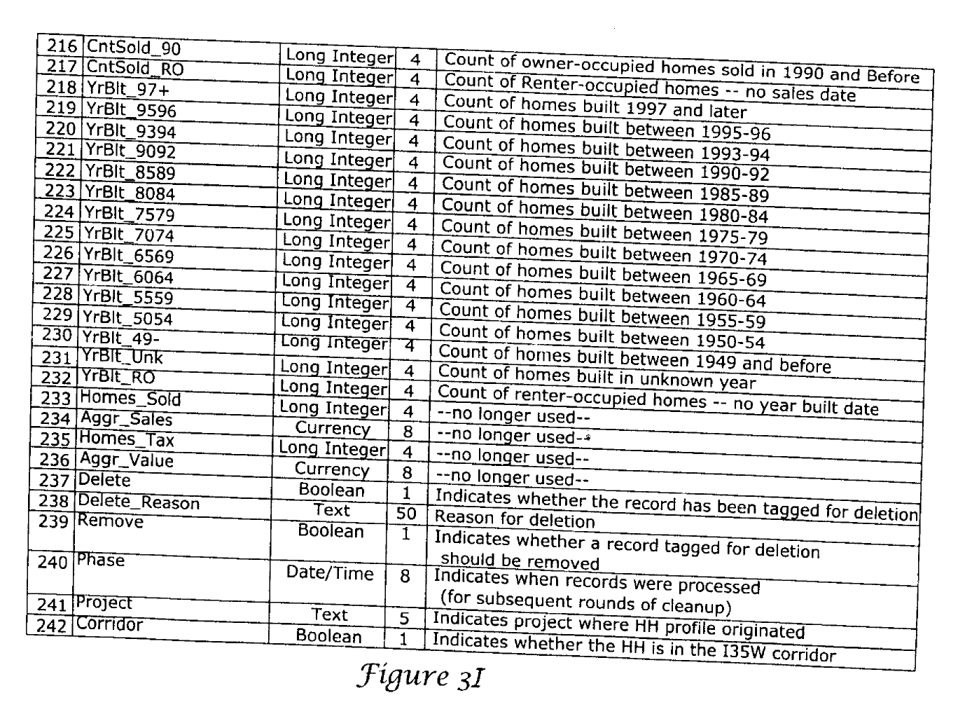

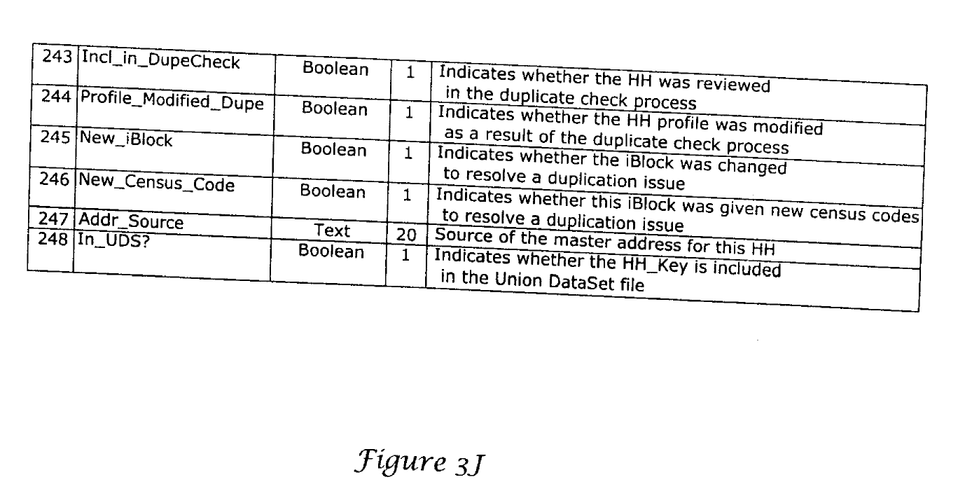

Next, and as shown at 66, household profiles may be created. Individual records in the resident-specific dataset may be collapsed into one profile record for each household. Then, a number of summary demographic parameters may be generated for each household or street address, as shown at 68. For example, the number of people, including children, in each household may be derived from the household profile records. Alternatively, or in addition, the summary demographic parameters may be created directly from the resident-specific dataset. FIGS. 3A-3J show a sample layout of a household profile record. Again, if the information in the household profile datasets is incomplete, the summary demographic variables shown in FIGS. 3A-3J can be modeled or otherwise estimated in a manner similar to that described above.

To protect the identity of the individual residents or households within a predefined geographic region, the demographic data for each household profile and/or household profile summary is preferably rolled together with at least one other household, but more preferably two and yet more preferably three to four neighboring households. This creates a number of geo-demographic cluster areas, shown generally at 70. The maximum number of households in a geo-demographic cluster area can be selected to provide the desired level of precision needed for a study or analysis, but will often be preferably less than one hundred households, more preferably less than twenty-five households, still more preferably less than ten households and most preferably less than four households.

In one embodiment, each set of three to five neighboring households are manually selected using a GIS map of the predefined geographic area. The map may be shown on a computer display using ArcView GIS software or the like. It is contemplated that this may be automated, if desired. A number of checks may then be performed, such as ensuring that none of the selected sets of households cross political or planning boundaries, that minimum criteria for data summary and data privacy standards are met, etc. Once checked, a new base map layer may be created for the ArcView GIS software that displays a boundary around each of the sets of households on the map of the predefined geographic region. Each set of households corresponds to one of the geo-demographic cluster areas, as described above.

In a preferred embodiment, a number of summary demographic variables are generated for each geo-demographic cluster area dataset. This is preferably accomplished by collapsing the summary demographic variables established for each household into a corresponding summary record for each set of households. One such summary record is shown in the Appendix. Each of the fields listed in the Appendix are either extracted directly from the household profile data sets or from the corresponding summaries thereof. A user of the demographic data is preferably only given access to or able to generate queries from the geo-demographic cluster area data sets but not the demographic data at the individual household level.

It should be understood that the steps in the above processes may be performed in an order different from the above listed order, and that some steps may be added and/or omitted without deviating from the spirit or scope of the invention. It is anticipated that in some applications, two or more steps may be performed more or less simultaneously to promote efficiency.

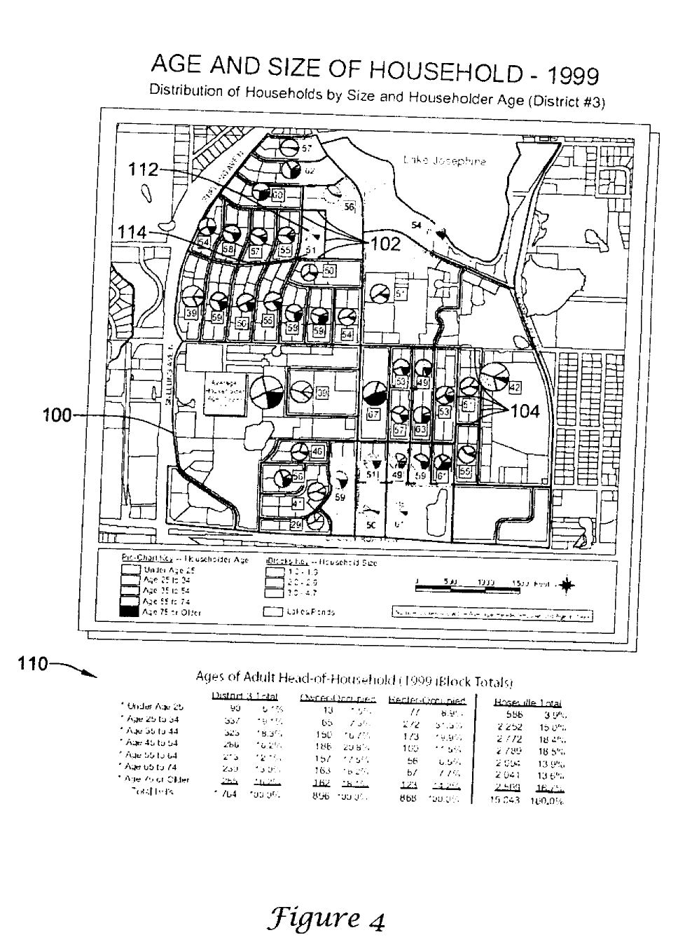

The various demographic variables in each geo-demographic cluster area dataset may be displayed on a map, if desired. One illustrative map is shown in FIG. 4. FIG. 4 shows a GIS map of a predefined geographic region, which is outlined by an outer boundary 100. Also shown are a number of local boundaries, each extending around a corresponding set of households. Two such local boundaries are shown at 102 and 104. Each local boundary 102 and 104 preferably corresponds to one or more of the geo-demographic cluster area datasets described above.

Some of the demographic parameters generated by the present invention may represent a certain percentage of a whole. For example, a set of parameters of a geo-demographic cluster area dataset or a summary thereof may correspond to a percentage of the households within the geo-demographic cluster area that have a head of household within a certain age range. For example, a first parameter may specify the percentage of head of households that are under 25 years of age. Another related parameter may specify the percentage of head of households that are between 25 and 34 years of age, as so on. A last parameter may specify the percentage of head of households that are greater than 75 years of age, thus accounting for all possible ages. These parameters are generally shown at 110 of FIG. 4.

To display this information, a pie chart may be displayed over each set of street addresses, households, parcels of land or other identifiers represented by a geo-demographic cluster area data set. For example, the set of households outlined by boundary 102 has a pie chart 112. Each pie chart preferably has a pie section that corresponds to each of the related parameters, and each pie section is preferably sized to correspond to the percentage that the corresponding parameter represents relative to the whole. An average of the related parameters may also be displayed adjacent each pie chart, as shown at 114.

While FIG. 4 is directed at displaying the age distribution of the head of households, other parameters can be likewise displayed. For example, pie charts may be used to display the distribution of year of sale for residential properties over the past 10 years, income distribution, ethnicity distribution, distribution of adult households with no children, adult households with children at home, and senior citizen households, distribution of owner-occupied turnover, distribution of workforce concentrations, distribution of building age, distribution of building size, distribution of property values, distribution of owner/renter occupancy, etc.

Having thus described the preferred embodiments of the present invention, those of skill in the art will readily appreciate that the teachings found herein may be applied to yet other embodiments within the scope of the claims hereto attached.

What is claimed is:

1. A method for providing demographic information for a geo-demographic cluster area within a predefined geographic region, the method comprising:
providing a first database, the first database having a number of data records that directly or indirectly relate to occupants in the predefined geographic region;
providing a second database, the second database having a number of different data records that directly or indirectly relate to occupants in the predefined geographic region;
associating selected data entries in the first and second databases with parcels of land;
generating household-specific demographic profiles for each parcel of land using the data records in the first and second databases; and
generating an aggregate data set for at least two parcels of land by combining the household-specific demographic profiles for each of the at least two parcels of land.
